(19) United States
(12) Patent Application Publication
(10) Pub. No.: US 2005/0165555 A1
(43) Pub. Date: Jul. 28, 2005

(54) 3-D visualized data set for all types of reservoir data

(75) Inventor: James C. Jackson, Houston, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/034,043

(22) Filed: Jan. 12, 2005

Related U.S. Application Data
(60) Provisional application No. 60/536,028, filed on Jan. 13, 2004.
(60) Provisional application No. 60/563,196, filed on Apr. 16, 2004.

(51) Int. Cl. G06F 19/00

(52) U.S. Cl. 702/16

(57) ABSTRACT

A visualization program is embedded with data that is to be visualized. The program is restricted to accessing only the data with that is embedded within. The combination of the program and the data may be delivered to an end-user either on a machine readable medium or by a communication link such as the Internet.

### CROSS-REFERENCES TO RELATED APPLICATIONS

This application claims priority from U.S. Provisional Patent Application Ser. No. 60/536,028 filed on Jan. 13, 2004 and U.S. Provisional Patent Application Ser. No. 60/563,196 filed on Apr. 16, 2004.

### BACKGROUND OF THE INVENTION

1. Field of the Invention

The present invention relates to methods of interacting and manipulating computer graphics and more particularly, relates to methods of interacting and manipulating, via display screen initiated instructions and displayed 3-dimensional (3-D) computer graphics, a variety of data indicative of subsurface earth formations.

2. Description of the Related Art

Computer-intensive processing of reflection seismic data is the main tool for imaging the Earth's subsurface to identify hydrocarbon reservoirs and determine rock and fluid properties. The seismic data may be surface reflection data or may include vertical seismic profile (VSP) data wherein a seismic source at or near the surface propagates seismic waves into the earth and data are received by seismic detectors in a wellbore.

An important aspect of exploration for mineral resources is the interpretation of a variety of data relating to the interface. This interpretation is based on a visualization of the subsurface in 3-D using computer graphics. The types of data that are visualized include surface seismic and VSP data, geologic data, data from wells drilled into the subsurface, and information about the velocities of seismic waves in the subsurface.

U.S. Pat. No. 5,617,548 to West et al. discloses a system for interacting with computer graphics. Included in the teachings of West is the ability to handle a variety of data types. There are a variety of commercial packages available to users for graphical display of 3-D volumes of the earth. For example, Well Seismic Fusion™ offered as a service by Landmark Graphics Corporation is a streamlined process for interactively integrating well data, synthetic seismic data and pre-stack seismic data. Observed relationships between well data and pre-stack seismic data lead to an improved understanding of fluid and lithologic variations within the reservoir and reservoir property uncertainty, enabling geoscientists to find the most economic parts of a reservoir. The ProMAX®, also offered by Landmark Graphics, is a seismic data processing family includes a complete suite of geophysical applications for 2D, 3D, VSP and depth imaging. VISUS (offered by GeoTomo LLC) is a 3D VSP visualization and interpretation package. 3D VSP visualization often involves multiple datasets with a large number of different types of property parameters. 3D interpretive integration of these multiple datasets will better characterize reservoir structures. The design objective of VISUS is to simplify the display control while still offering the geophysicist a great deal of flexibility for data display and manipulation.

A limitation of the commercially available systems such as those identified above is that they are computer intensive and are typically implemented on a workstation. Portability, particularly to wellsites, is thus limited. A drawback is that the person interpreting the graphics display needs to also be an expert in seismic data processing. In addition, a relatively high level of computer literacy is needed on the part of the interpreter. In many instances, the interpreter has a geologic or petrophysics background, so that the expertise in seismic processing and computer literacy may be lacking. In addition, a license to use the software can be expensive.

U.S. Pat. No. 6,493,635 to Bevc et al. discloses a geophysical data processing that is remotely controlled and monitored over a wide-area network such as the Internet. A customer using a client computer builds geophysical data processing flows (concatenations of geophysical data processing modules or filters) and enters parameter values required for flow execution. The flow descriptions and associated parameter values are then transferred from the client to a geophysical data processing server, for example a parallel supercomputer. The flows (jobs) are executed on the server, typically over periods ranging from hours to weeks. Intermediate or partial results are made available to the customer for visualization before the processing of a flow is complete. The customer can then modify the flow before its complete execution. Data-entry windows are automatically generated for geophysical processing modules by parsing the source code of the modules. The automatic generation of data-entry windows allows relatively simple integration of new seismic interpretation packages with a given graphical user interface. Bevc thus addresses one of the limitations discussed above in that the end user can operate from a PC. This provides a high level of portability. The other drawbacks of the required expertise on the part of the user, and the licensing requirements are not addressed. In addition, the interpretation process is quite time consuming which precludes use at wellsites.

U.S. Pat. No. 6,658,567 to Barton teaches the use of a lock and key arrangement in which one or more data sets are tied to a program for analyzing wellbore image data. While there is a teaching in Barton that geomechanical, geophysical, in situ stress, petrophysical, geotechnical and acoustic data may be analyzed, there is no specific teaching of how to integrate surface seismic data, VSP data, and well trajectories that are necessary to perform an integrated analysis of a reservoir. Generally, the different types of data are stored in a variety of data formats. These would appear to be unacceptable to the analyzer in Barton. In addition, since it includes an analysis program, the user must be conversant with analysis methods.

There is a need for an invention that is portable, relatively inexpensive, portable, and provides the ability to visualize 3-D volumes of the subsurface with a variety of data, including surface seismic and VSP, well logs, geologic and petrophysical data. The present invention satisfies this need.

### SUMMARY OF THE INVENTION

One embodiment of the present invention is a machine readable medium that includes at least one data set relating to a subterranean earth formation and a visualization program embedded with the at least one data set. The visualization program provides a visual display of the at least one data set. The visualization program is configured to be incapable of providing a visual display of any data other than the at least one data set with which it is embedded. The medium may be a portable medium selected from a CD-ROM, a DVD disc, optical disc, or magnetic tape. Alternatively, the medium may be a storage device on a server accessible by an end user.

The data set may be one or more of 3-D surface seismic data, VSP data, a well log, a well trajectory, velocity data, seismic raypaths, seismic horizons, locations of seismic sources, seismic attributes, or 2-D surface seismic data. The data may be in any one of a variety of commonly used formats used in the field of hydrocarbon exploration. The visual display includes may include a gridded display of a subterranean interface, or a transparency display of a subterranean interface.

In another embodiment, the invention is a method of enabling visualizing a subterranean earth formation by providing access to one or more data set relating to the subterranean earth formation, and providing a visualization program for providing a visual display of the data set, while configuring visualization program to be incapable of providing a visual display of any data other than the provided data. The visualization program and the data may be provided on a portable medium, such as a CD-ROM, a DVD disc, optical disc, or a magnetic tape. Alternatively, the program and the data may be installed on a machine readable medium with access provided to an end user over a communication link such as the Internet. When two or more data sets are provided, the visualization program has the capability of displaying, in a single display, the plurality of data sets.

### BRIEF DESCRIPTION OF THE DRAWINGS

The present invention is best understood by reference to the attached figures in which like numerals refer to like elements, and in which:

FIG. 1 is a schematic illustration of one embodiment of the present invention;

FIG. 2 is a schematic illustration of one embodiment of the present invention;

FIG. 3 is an exemplary display showing horizons, raypaths, a salt dome, well track;

FIG. 4 shows a detail of FIG. 3 showing reflection raypaths from a horizont to locations in a wellbore;

FIG. 5 shows a display including locations of surface seismic sources;

FIG. 6 is a display showing the transparency features;

FIG. 7 is a display showing raypaths, a velocity model, salt dome, wellpath and well log;

FIG. 8 is a display of a 3-D seismic volume, a wellpath and a VSP data along a seismic line;

FIG. 9 is a display of two lines of surface seismic data and salt exit points from a VSP survey; and

FIG. 10 is a display of two surface seismic lines, a 3D VSP data set and salt exit points.

### DETAILED DESCRIPTION OF THE INVENTION

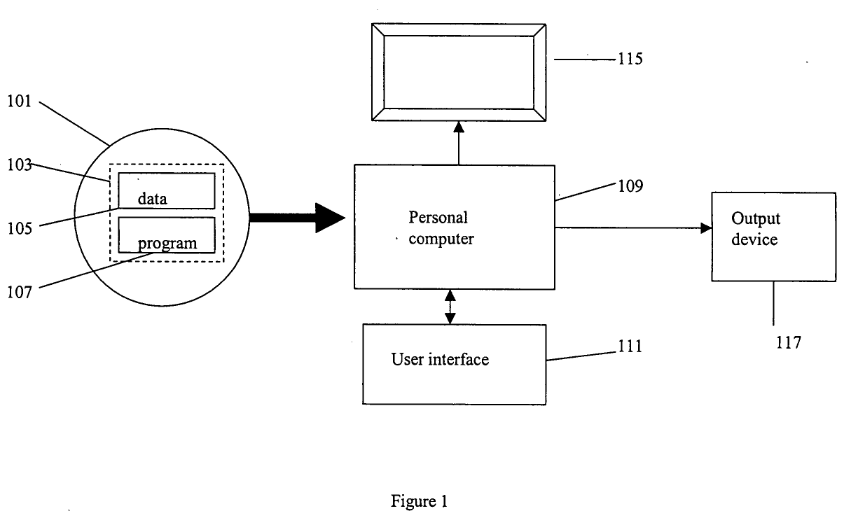

FIG. 1 shows the configuration for one embodiment of the present invention. A processing device 109 such as the processor of a PC or other convenient device has a display 115 such as a video monitor, flat screen display or LCD. A user interface 111 is provided. The user interface could include a keyboard, mouse, or any other device capable of communicating with the processor. The communication link could be hard wired or could be a wireless communication arrangement including but nor limited to electromagnetic links or infrared links. The processor 109 has been provided with a machine readable medium 101 such as a CD-ROM, DVD, magnetic tape or any other suitable medium. Included in the medium is packaged program 103 that includes an embedded visualization program 107 (that has the capability of displaying one or more types of data) and one or more data sets 105. In one embodiment of the present invention, the program 107 is a version of the program VISUS marketed by GeoTomo LLC. The program VISUS itself has the capability of displaying many types of data, included but not limited to 3-D surface seismic data, VSP data, a well log, a well trajectory, velocity data, seismic raypaths, seismic horizons, locations of seismic sources, seismic attributes, and 2-D surface seismic data. In the present invention, by the embedding process, only the data set 105 can be accessed. When the machine readable medium is loaded onto the processor 109, the packaged program 103 may then be executed on the processor, but with the ability to visualize only data set 105.1t should be noted that the use of the VISUS program is only for exemplary purposes, and the present invention may also be used with any other program that is capable of displaying different types of data. The present invention is thus different in several aspects from that taught by Barton.

The website of Geomechanics International (assignee of the Barton patent), refers to an analyzer program GMI Imager™. As noted at col. 2 lines 30-38 of Barton:
For the purposes of the present specification, the term “analyzer program” shall be taken to refer to any program that analyzes data for the purpose of presenting, interpreting or modifying the data. Accordingly, the operations performed by an analyzer program include, but are not limited to, the extraction of data, the generating of data, the interpretation of data, the display of data, the filtering of data, and the enhancing of data.
   In contrast, the present invention includes a visualization program that manipulates preprocessed data of different types in a variety of formats. Thus, in the present invention, it is assumed that the preprocessing has been done by those skilled in the art of processing, and the user of the present invention is an interpreter who is skilled in integrating different types of data.

In addition, Barton embeds a key into an external data file and a key into separate Java application. Keys must match for the program to run. The program and data files remain separate. The present invention embeds the data directly into the 3D viewer application. The data files are not modified in any way. There are no keys. Data are internal, not external to the application. A single file contains customer's data files and the viewer executable.

In one embodiment of the invention, the packaged program 103 is an excecutable object code. The object code is obtained by (i) taking the source code for a program such as VISUS, (ii) combining it with one or more specified data sets, and, (iii) compiling into an object code the combination. By the process of compilation, the data set 105 and the visualization program 107 are embedded into the packaged program 103. With such an arrangement, the only external links available to the user relate to selection of one or more of the specified data sets and the display options. There is no need for a lock and key arrangement of the type disclosed in Barton.

Using the packaged program 103, the user can then manipulate and display the data in various modes on the display 115. The user also has the capability of doing a certain amount of editing of the data, and output the results to an output device 117 such as a printer.

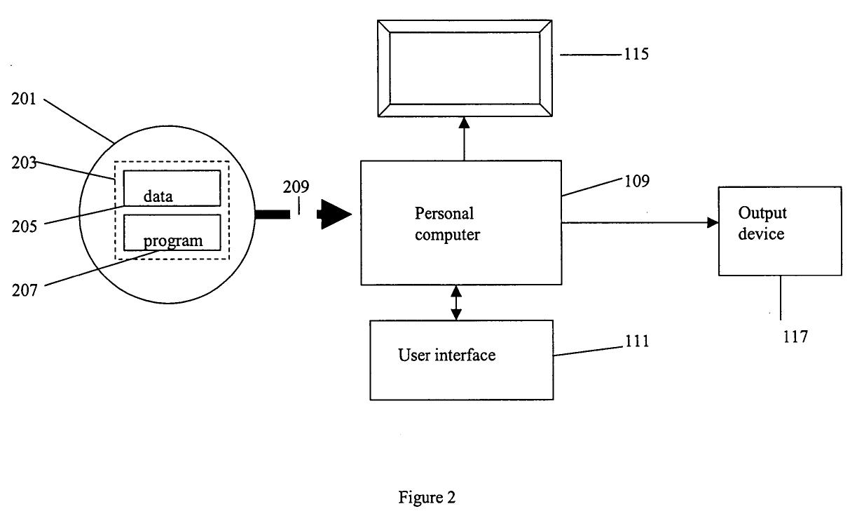

Turning now to FIG. 2, another embodiment of the present invention is illustrated. In the same manner as in FIG. 1, the processing device 109 such as the processor of a PC or other convenient device has a display 115 such as a video monitor, flat screen display or LCD. A user interface 111 is provided. The user interface could include a keyboard, mouse, or any other device capable of communicating with the processor. The communication link could be hard wired or could be a wireless communication arrangement including but nor limited to electromagnetic links or infrared links. The key point of difference from FIG. 1 is that processor 109 accesses the packaged program 203 (that includes the capabilities of visualization program 207 and the data 205) through a communication link 209. The communication link could be any network, including the Internet. The data 205 and the program 207 that are embedded in the packaged program 203 are on a machine readable medium 201 at a suitable location on the network. The suitable location on the network could be a server provided by the vendor. The end user then has the capability of accessing the packaged program 207 and visualizing the data set 205 after providing certain user information to the vendor. In one embodiment of the present invention, the program 207 is the program VISUS marketed by GeoTomo LLC. The program VISUS itself has the capability of displaying many types of data, included but not limited to 3-D surface seismic data, VSP data, a well log, a well trajectory, velocity data, seismic raypaths, seismic horizons, locations of seismic sources, seismic attributes, and 2-D surface seismic data. In the present invention, the packaged program 203 can only be used for visualizing the data set 205. It should be noted that the use of the VISUS program is only for exemplary purposes, and the present invention may also be used with any other program that is capable of displaying different types of data.

The user can then access the packaged program 203 including the data set 205 through the interface 111. Using the capabilities of program 207, the user can then manipulate and display the data in various modes on the display 115. The user also has the capability of doing a certain amount of editing of the data, and output the results to an output device 117 such as a printer. The various types of displays available with the present invention for different types of data are discussed next. All of the examples are from substantially the same portion of the subsurface, with the different examples being selected to show some of the capabilities of the invention.

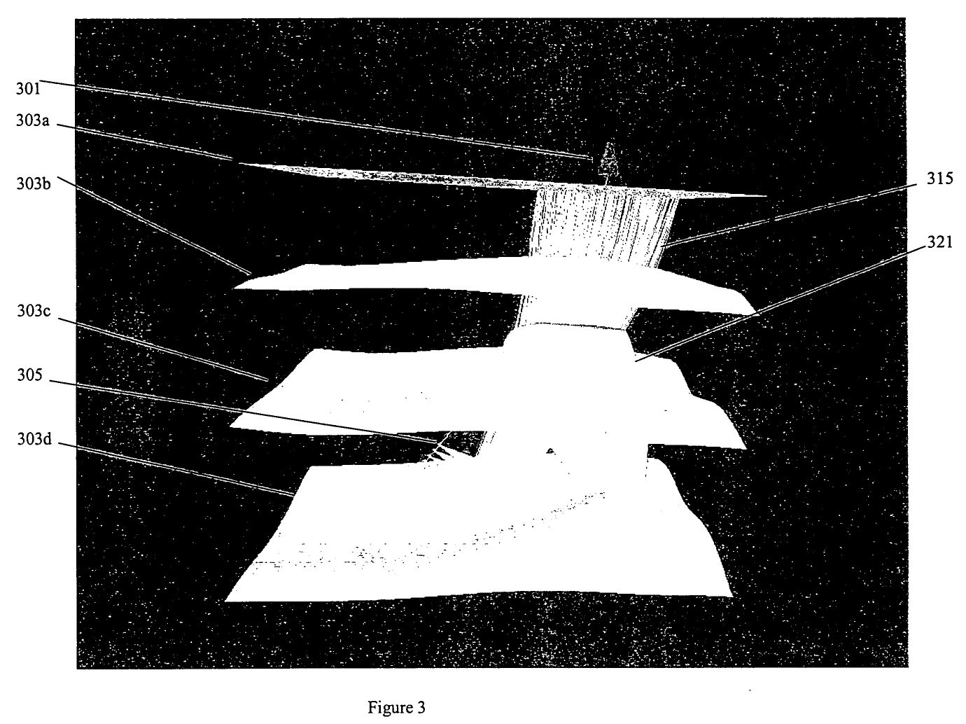

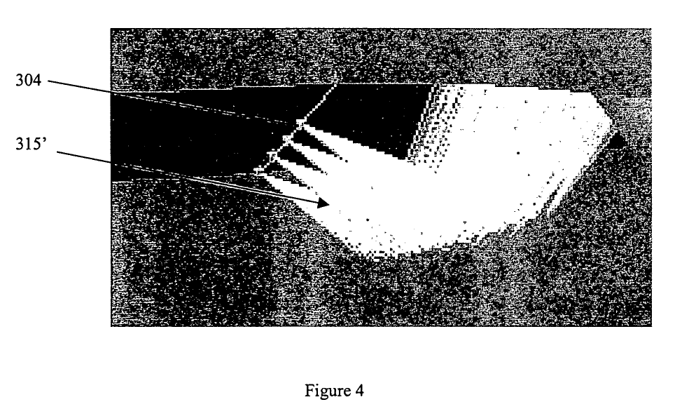

Turning now to FIG. 3, a well with a surface location denoted by 301 is located at a location on a surface 303a. A plurality of horizons 303b, 303c and 303d are shown in FIG. 3. Also shown in FIG. 3 is a salt dome 321. Raypaths from a plurality of surface locations to selected locations near the bottom of the wellbore 305 are collectively denoted by 315. In the example shown, the raypaths 315 pass through the salt dome, are reflected by the horizon 303d into the wellbore 305. A detail of the reflected raypaths 315′ is shown in FIG. 4. The point to note here is that all the information that is used for producing the displays of FIGS. 3 and 4 is present in the data files 103 or 203. The program 107 or 207 displays these different kinds of data. The data files themselves may be generated elsewhere. With the present invention, an end user can visually examine the data and make interpretations regarding the subsurface with relatively little computer literacy or expertise in seismic data processing.

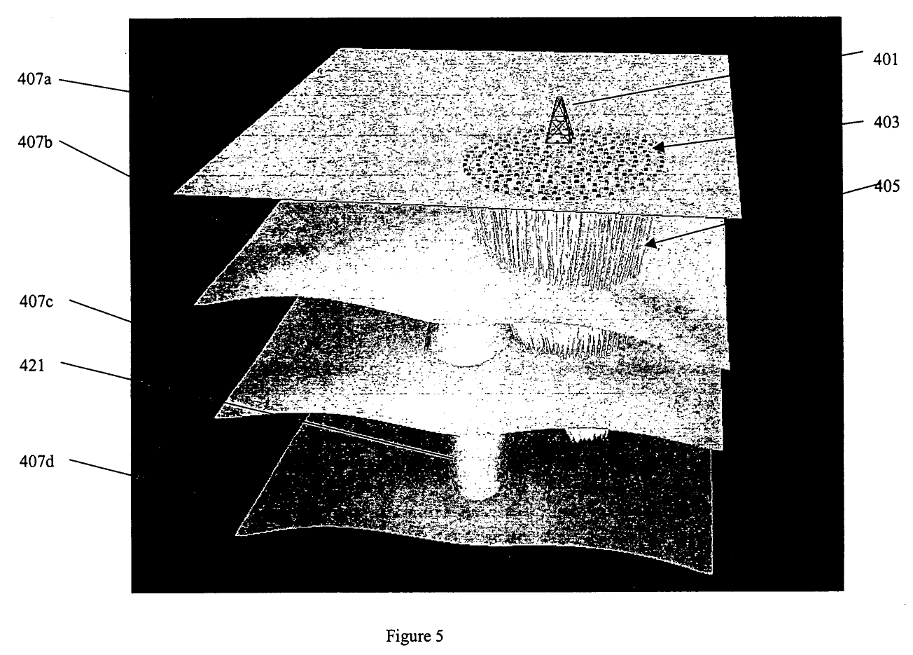

Turning next to FIG. 5, another exemplary plot of substantially the same data as in FIGS. 3 and 4 is shown. The surface and subsurface horizons are indicated by 407a, 407b, 407c and 407d. The salt dome is indicated by 421. The surface locations of the seismic sources are indicated by 403 while the raypaths from the surface are denoted by 405. In this particular example, the wellbore is not visible. However, viewing this display, the interpreter can get a feeling for the portion of the subsurface that is insonified from the surface locations 403.

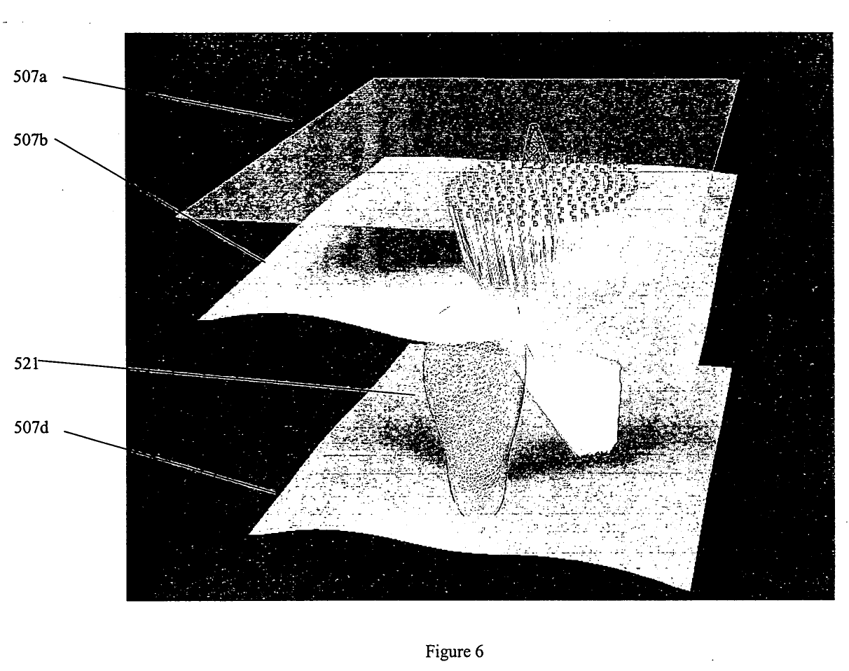

Another exemplary display from the same perspective as in FIG. 5 is shown in FIG. 6. One difference from FIG. 5 is that the salt dome is now depicted by a grid of points rather than appearing as a solid surface. In addition, the surface 507a appears to be transparent, making it easier to visualize the raypaths in the near surface.

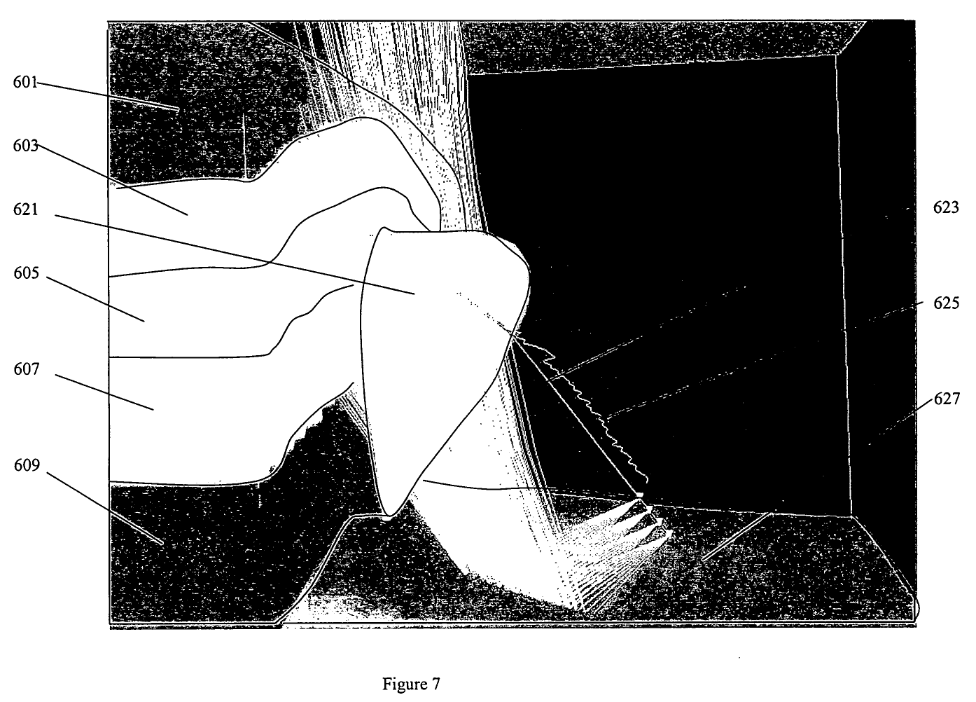

Turning now to FIG. 7, a display is shown with the salt dome 621, well path 623, well log 625 and raypaths reflecting from a horizon 625. Also shown in the figure is a velocity model with velocity regions generally defined by 601, 603, 605, 607 and 609, the boundaries between the velocity regions being iso-velocity countours. With such a display, the end user can see the effects of the velocity model on the bending of the rays from the surface.

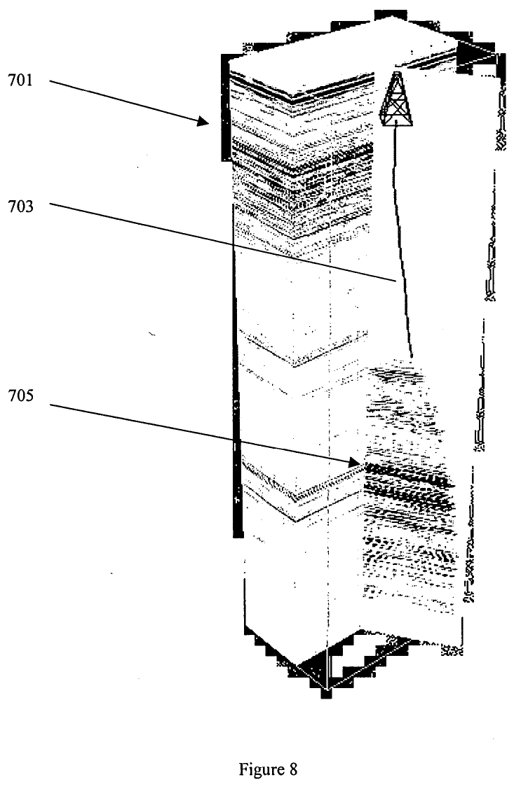

The present invention also has the capability of displaying seismic data volumes and lines. This is illustrated in FIG. 8 which generally shows a 3-D seismic data volume 701 obtained from surface seismic data along with a wellpath 703. Also included in the display is a line of VSP seismic data recorded at the wellpath. With such a display, the end user can readily compare the surface seismic data with VSP data. Differences between the two sets of seismic data are indicative of possible errors in processing. In addition, when combined with raypath displays, it is possible for the end-user to identify seismic reflections in the 3-D volume with the correct spatial position from which reflections originate.

Many hydrocarbon reservoirs are formed by the truncation of porous reservoir rock against salt bodies, typically salt domes. Once a reservoir has been located, one of the important aspects of reservoir development is the drilling of additional wells to be able to recover as much of the hydrocarbons in place as possible. In order to do this, additional wells are drilled as close to the salt face as possible. However, if the additional wells are improperly located and drill into the salt dome, serious problems can arise. First, if the well is actually within the salt dome, it is useless for recovering hydrocarbons, so that the cost the well is a total waste. Secondly, drilling into salt with a water based mud can cause a catastrophic collapse of the well: something to be avoided. For this reason, a special type of survey called a “salt proximity survey” may be carried out. This may be done as part of a VSP but with the source and receiver configuration selected to give information relating to the salt face near the wellbore. Alternatively, a salt proximity survey may be carried out with sources and receivers in the wellbore for mapping seismic reflections from the salt face.

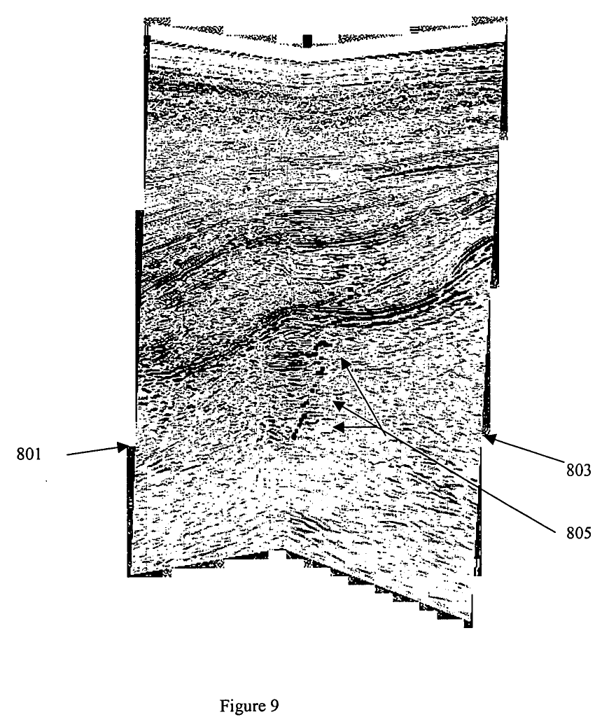

One of the diagnostics that may be obtained with a VSP survey is a determination of the point at which seismic rays emerge from the salt. An example of this is shown in FIG. 9. Shown therein are two seismic lines generally denoted by 801 and 803. In addition, a plurality of points generally denoted by 805 is shown. These points 805 are the exit points for raypaths from surface seismic sources to receivers in the wellbore.

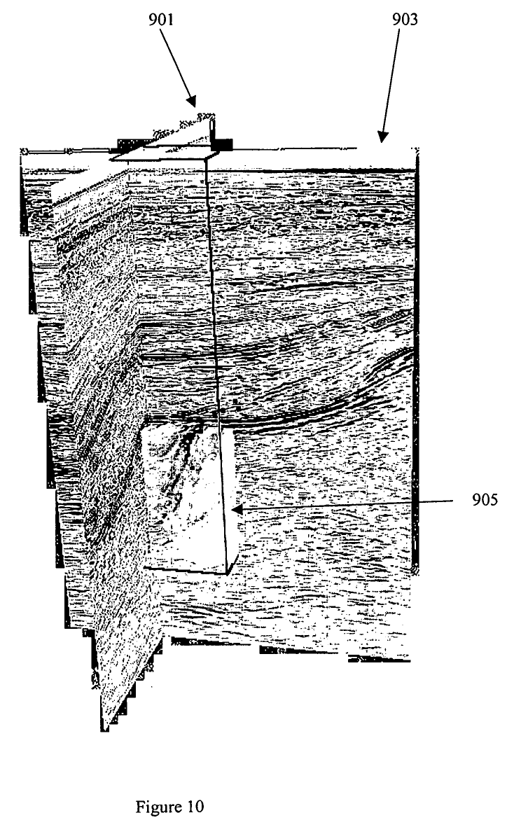

Another useful display that may be obtained is shown in FIG. 10. Two surface seismic lines 901 and 903 are shown, along with a 3D VSP data volume 905. Salt exit points are also shown in the figure. With such a display, it is possible to compare the VSP data with surface seismic lines, do QC on the VSP and surface data, an visualize the subsurface structure (in this case, details of the proximity of the salt to the wellbore). All of these capabilities are useful in reservoir development.

While the foregoing disclosure is directed to the preferred embodiments of the invention, various modifications will be apparent to those skilled in the art. It is intended that all such variations within the scope and spirit of the appended claims be embraced by the foregoing disclosure.

1. A machine readable medium comprising:
(a) a packaged program having a capability for visualization; and
(b) at least one preprocessed data set included in said packaged program;
wherein said packaged program is adapted to provide a visual display of only said at least one preprocessed data set.

2. The medium of claim 1 wherein said medium comprises a portable medium.

3. The medium of claim 2 wherein said medium comprises at least one of (i) a CD-ROM, (ii) a DVD disc, (iii) a magnetic tape, and, (iv) an optical disc.

4. The medium of claim 1 wherein said medium comprises a storage device on a server accessible by an end user.

5. The medium of claim 1 wherein said at least one data set is selected from the group consisting of (i) 3-D surface seismic data, (ii) VSP data, (iii) a well log, (iv) a well trajectory, (v) velocity data, (vi) seismic raypaths, (vii) seismic horizons, (viii) locations of seismic sources, (ix) seismic attributes, and (x) 2-D surface seismic data.

6. The medium of claim 1 wherein said visual display includes at least one of (i) a gridded display of a subterranean interface, and, (ii) a transparency display of a subterranean interface.

7. A method of enabling visualizing a subterranean earth formation comprising:
(a) providing access to at least one preprocessed data set relating to said subterranean earth formation;
(b) providing a visualization program for providing a visual display of at said least data set,
wherein said at least one preprocessed data set is included in said visualization program.

8. The method of claim 7 further comprising providing said at least one data set and said visualization program on a portable medium.

9. The method of claim 8 wherein said medium comprises at least one of (i) a CD-ROM, (ii) a DVD disc, (iii) a magnetic tape, and, (iv) an optical disc.

10. The method of claim 7 further comprising:
(i) providing said at least one data set and said visualization program on a machine readable medium; and
(ii) enabling access of an end user to said machine readable medium over a communication link.

11. The method of claim 10 wherein said machine readable medium further comprises a memory device on a server.

12. The method of claim 10 wherein said communication link comprises the Internet.

13. The method of claim 7 wherein said at least one data set is selected from the group consisting of (i) 3-D surface seismic data, (ii) VSP data, (iii) a well log, (iv) a well trajectory, (v) velocity data, (vi) seismic raypaths, (vii) seismic horizons, (viii) locations of seismic sources, (ix) seismic attributes, and (x) 2-D surface seismic data.

14. The method of claim 7 wherein providing said at least one data set comprises at least two data sets and providing said visual display further comprises providing said visual display further comprises providing in a single display said at least two data sets.
